(19) United States
(12) Patent Application Publication
(10) Pub. No.: US 2020/0282879 A1
(43) Pub. Date: Sep. 10, 2020

(54) Recliner Heart For Seat Assembly

(71) Applicant: FISHER & COMPANY, INCORPORATED, St. Clair Shores, MI (US)

(72) Inventors: Ralph L. SCHMITZ, Clinton Township, MI (US); Sapan M. POPTANI, Northville, MI (US)

(73) Assignee: FISHER & COMPANY, INCORPORATED, St. Clair Shores, MI (US)

(21) Appl. No.: 16/811,112

(22) Filed: Mar. 6, 2020

Related U.S. Application Data
(60) Provisional application No. 62/814,320, filed on Mar. 6, 2019.

(51) Int. Cl. B60N 2/433; B60N 2/235; B60N 2/22

(52) U.S. Cl. CPC B60N 2/433; B60N 2/2227; B60N 2/2362

(57) ABSTRACT

A recliner heart for a vehicle seat recliner assembly may include a first plate, a second plate and one or more pawls. The first plate may define a recess. The second plate may include a first inner diametrical surface having first teeth formed thereon. The pawl may be slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates. One or both lateral sides of the pawl may include one or more slots.

### CROSS-REFERENCE TO RELATED APPLICATIONS

This application claims the benefit of U.S. Provisional Application No. 62/814,320, filed on Mar. 6, 2019. The entire disclosure of the above application is incorporated herein by reference.

### FIELD

The present disclosure relates to a recliner heart for a seat assembly.

### BACKGROUND

This section provides background information related to the present disclosure and is not necessarily prior art.

Vehicle seats often include a recliner heart that can rotate a seatback relative to a seat bottom. A hand lever can be rotated to move the recliner heart between a locked position preventing relative rotation between the seatback and the seat bottom and an unlocked position permitting relative rotation between the seatback and the seat bottom. When a conventional recliner heart is in the locked position, tolerances between components of the recliner heart may allow some movement of the seatback relative to the seat bottom. The present disclosure provides a recliner heart that reduces or prevents movement of the seatback relative to the seat bottom when the recliner heart is in the locked position during an impact event.

Furthermore, when a vehicle in which a seat is installed travels across rough terrain, for example, and the recliner heart is in the locked position, tolerances between components of the recliner heart may allow for the components to generate noise due to vibration of the components. The present disclosure also provides a recliner heart that reduces vibration and noise.

### SUMMARY

This section provides a general summary of the disclosure, and is not a comprehensive disclosure of its full scope or all of its features.

In one form, the present disclosure provides a recliner heart that may include a first plate, a second plate and a pawl. The first plate defines a recess. The second plate includes a first inner diametrical surface having teeth formed thereon. The pawl is slidably disposed in the recess between a secure position in which the pawl is engaged with a portion of the teeth of the second platen to restrict relative rotation between the first and second plates and a release position in which the pawl is disengaged from the portion of the teeth of the second plate to allow relative rotation between the first and second plates. A lateral side of the pawl includes a first slot.

In some configurations of the recliner heart of the above paragraph, material from the first plate is allowed to deform into the first slot upon an impact event.

In some configurations of the recliner heart of any one or more of the above paragraphs, the first plate includes a plurality of protrusions. The pawl is disposed in the recess defined between two of the plurality of protrusions.

In some configurations of the recliner heart of any one or more of the above paragraphs, the lateral side of the pawl faces a lateral side of a respective protrusion of the two of the plurality of protrusions.

In some configurations of the recliner heart of any one or more of the above paragraphs, material from the respective protrusion is allowed to deform into the first slot upon an impact event.

In some configurations of the recliner heart of any one or more of the above paragraphs, the pawl is fixed in the recess when the pawl is in the secure position and material from the respective protrusion deforms into the first slot.

In some configurations of the recliner heart of any one or more of the above paragraphs, a plurality of first walls cooperate to define the first slot.

In some configurations of the recliner heart of any one or more of the above paragraphs, at least one of the plurality of first walls is angled.

In some configurations of the recliner heart of any one or more of the above paragraphs, a second slot is formed in an opposing lateral side of the pawl.

In some configurations of the recliner heart of any one or more of the above paragraphs, a second slot is formed in the lateral side of the pawl. Material from the respective protrusion is allowed to deform into the second slot upon the impact event.

In some configurations of the recliner heart of any one or more of the above paragraphs, a plurality of second walls cooperate to define the second slot.

In another form, the present disclosure provides a recliner heart that may include a first plate, a second plate and a pawl. The first plate includes a plate surface having a plurality of protrusions extending therefrom. Two of the plurality of protrusions define a recess therebetween. The second plate includes a first inner diametrical surface having teeth formed thereon. The pawl is slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates. Opposing lateral sides of the pawl include a first pair of slots.

In some configurations of the recliner heart of the above paragraph, each lateral side of the pawl faces a lateral side of a respective protrusion of the two of the plurality of protrusions.

In some configurations of the recliner heart of any one or more of the above paragraphs, material from one of the two of the plurality of protrusions is allowed to deform into one slot of the first pair of slots upon an impact event.

In some configurations of the recliner heart of any one or more of the above paragraphs, the pawl is fixed in the recess when the pawl is in the secure position and material from the one of the two of the plurality of protrusions deform into the one slot of the first pair of slots.

In some configurations of the recliner heart of any one or more of the above paragraphs, a plurality of first walls cooperate to define each slot of the first pair of slots.

In some configurations of the recliner heart of any one or more of the above paragraphs, at least one of the plurality of first walls is angled relative to the opposing lateral sides of the pawl.

In some configurations of the recliner heart of any one or more of the above paragraphs, the pawl includes a second pair of slots formed in the opposing lateral sides. Material from the first plate is allowed to deform into one slot of the first pair of slots and one slot of the second pair of slots upon an impact event.

In some configurations of the recliner heart of any one or more of the above paragraphs, the pawl includes a second pair of slots formed in the opposing lateral sides. Material from the one of the two of the plurality of protrusions is allowed to deform into one slot of the second pair of slots upon the impact event.

In some configurations of the recliner heart of any one or more of the above paragraphs, a plurality of second walls cooperate to define each slot of the second pair of slots. At least one of the plurality of second walls is angled relative to the opposing lateral sides of the pawl.

In another form, the present disclosure provides a recliner heart that may include a first plate, a second plate, a pawl and a first compression member. The first plate defines a recess. The second plate includes a first inner diametrical surface having teeth formed thereon. The pawl is slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates. The pawl includes a lateral side that has a first slot. The first compression member is disposed in the first slot and is configured to dampen vibration of the pawl and the first plate.

In some configurations of the recliner heart of the above paragraph, the first compression member is force-fitted into the first slot so that the first compression member is under compression in the first slot.

In some configurations of the recliner heart of any one or more of the above paragraphs, the first plate includes a plurality of protrusions that define the recess.

In some configurations of the recliner heart of any one or more of the above paragraphs, the first plate includes a plurality of protrusions. The pawl is disposed in the recess defined between two of the plurality of protrusions.

In some configurations of the recliner heart of any one or more of the above paragraphs, the lateral side of the pawl faces a lateral side of a respective one of protrusions. A clearance gap exists between the lateral side of the pawl and the lateral side of the respective one of the protrusions.

In some configurations of the recliner heart of any one or more of the above paragraphs, a plurality of first walls cooperate to define the first slot. The first compression member is in contact with one of the first walls and the lateral side of the respective protrusion.

In some configurations of the recliner heart of any one or more of the above paragraphs, the one of the first walls and the lateral side of the respective protrusion extend parallel to each other.

In some configurations of the recliner heart of any one or more of the above paragraphs, a second slot is formed in the lateral side of the pawl. A second compression member is disposed in the second slot and configured to dampen vibration of the pawl and the first plate.

In some configurations of the recliner heart of any one or more of the above paragraphs, the second compression member is made of a polymeric material.

In some configurations of the recliner heart of any one or more of the above paragraphs, a plurality of second walls cooperate to define the second slot. The second compression member is in contact with one of the second walls and the lateral side of the respective protrusion.

In some configurations of the recliner heart of any one or more of the above paragraphs, the first compression member is made of a polymeric material.

In another form, the present disclosure provides a recliner heart that may include a first plate, a second plate, a pawl and first compression members. The first plate includes a plate surface having a plurality of protrusions extending therefrom. Two of the plurality of protrusions defines a recess therebetween. The second plate includes a first inner diametrical surface having teeth formed thereon. The pawl is slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates. The pawl includes opposing lateral sides. Each of the lateral sides includes a first slot. A first compression member is disposed in each of the first slots and configured to dampen vibration of the pawl and the first plate.

In some configurations of the recliner heart of the above paragraph, the first compression members are force-fitted into the first slots so that the first compression members are under compression in the first slots.

In some configurations of the recliner heart of any one or more of the above paragraphs, each lateral side of the pawl faces a lateral side of a respective protrusion of the two of the plurality of protrusions.

In some configurations of the recliner heart of any one or more of the above paragraphs, a clearance gap exists between each lateral side of the pawl and the lateral side of the respective protrusion.

In some configurations of the recliner heart of any one or more of the above paragraphs, a plurality of first walls cooperate to define each slot of the first slots. Each first compression member is in contact with one of the first walls and the lateral side of the respective protrusion.

In some configurations of the recliner heart of any one or more of the above paragraphs, the one of the first walls and the lateral side of the respective protrusion extend parallel to each other.

In some configurations of the recliner heart of any one or more of the above paragraphs, each of the lateral sides of the pawl includes a second slot. A second compression member is disposed in each of the second slots and are configured to dampen vibration of the pawl and the first plate.

In some configurations of the recliner heart of any one or more of the above paragraphs, a plurality of second walls cooperate to define each slot of the second slots. Each second compression member is in contact with one of the second walls and the lateral side of the respective protrusion.

In some configurations of the recliner heart of any one or more of the above paragraphs, the second compression members are made of a polymeric material.

In some configurations of the recliner heart of any one or more of the above paragraphs, the first compression members are made of a polymeric material.

In another form, the present disclosure provides a vehicle seat assembly that may include a seat bottom, a seatback, and a recliner mechanism. The seatback is movable relative to the seat bottom between an upright position and a reclined position. The recliner mechanism is connected to the seat bottom and the seatback and is operable to selectively allow and restrict movement of the seatback relative to the seat bottom. The recliner mechanism includes a recliner heat. The recliner heart may include a first plate, a second plate and a pawl. The first plate defines a recess. The second plate includes a first inner diametrical surface having teeth formed thereon. The pawl is slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates. A lateral side of the pawl includes a slot.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of a vehicle having a seat incorporating a recliner assembly according to the principles of the present disclosure;

FIG. 2 is a perspective view of the recliner assembly of FIG. 1;

FIG. 3 is an exploded view of a portion of the recliner assembly of FIG. 1;

FIG. 4 is a cross-sectional view of a recliner mechanism of the recliner assembly of FIG. 1 in an unlocked state;

FIG. 5 is a cross-sectional view of the recliner mechanism of the recliner assembly of FIG. 1 in a locked state;

FIG. 6 is a partial cross-sectional view of the recliner mechanism during an impact event;

FIG. 7 is a close-up view of a portion of the recliner mechanism indicated as area 7 in FIG. 6;

FIG. 8 is a close-up view of a portion of another recliner mechanism during an impact event;

FIG. 9 is a perspective view of alternate pawl of the recliner mechanism;

FIG. 10 is a partial perspective view of a vehicle having a seat incorporating a recliner assembly according to the principles of the present disclosure;

FIG. 11 is a perspective view of the recliner assembly of FIG. 1;

FIG. 12 is an exploded view of a portion of the recliner assembly of FIG. 10;

FIG. 13 is a cross-sectional view of a recliner mechanism of the recliner assembly of FIG. 10 in an unlocked state;

FIG. 14 is a cross-sectional view of the recliner mechanism of the recliner assembly of FIG. 10 in a locked state;

FIG. 15 is a partial cross-sectional view of the recliner mechanism of FIG. 14; and

FIG. 16 is an exaggerated close-up view of a portion of the recliner mechanism indicated as area 16 in FIG. 15.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

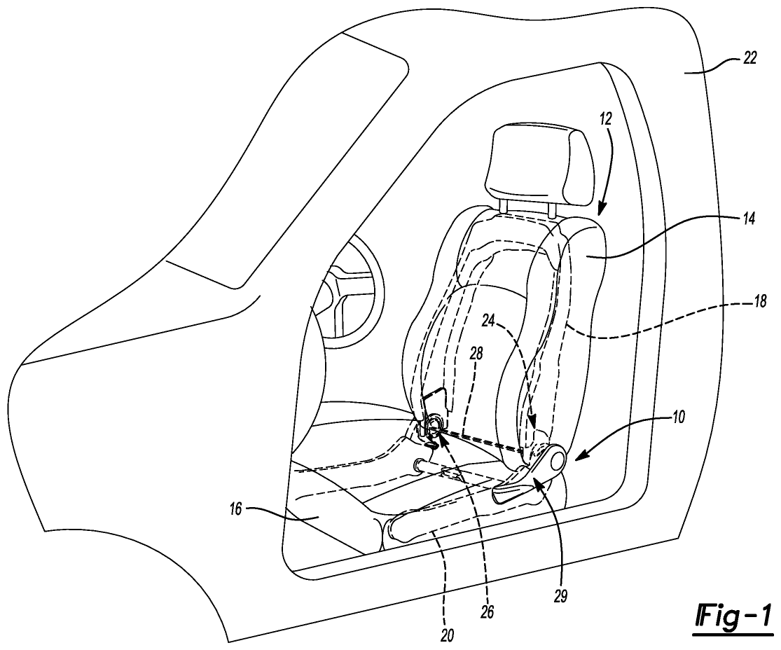

With reference to FIGS. 1-3, a recliner assembly 10 is provided that may be incorporated into a vehicle seat assembly 12 having a seatback 14 and a seat bottom 16. The seatback 14 and seat bottom 16 may include a seatback frame 18 and a seat bottom frame 20 respectively. The seat assembly 12 may be positioned in a vehicle 22, as shown in FIG. 1. The recliner assembly 10 may include a first recliner mechanism 24, a second recliner mechanism 26, a cross member 28, and a hand lever or release lever 29.

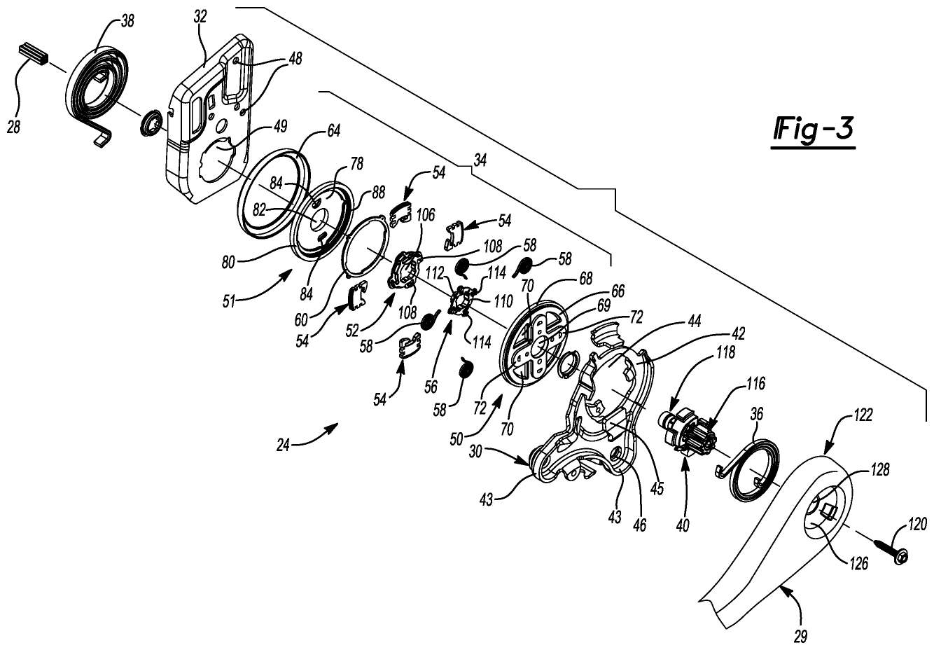

The first and second recliner mechanisms 24, 26 may be operable in a locked state preventing relative rotation between the seatback 14 and the seat bottom 16 and an unlocked state permitting relative rotation between the seatback 14 and the seat bottom 16 among an upright position (FIG. 1), a rearward reclined position (not shown) and a forward dump position (not shown). As shown in FIG. 3, the first recliner mechanism 24 may include a first bracket 30, a second bracket 32, a recliner heart (or locking mechanism) 34, an outer coil spring 36, an inner coil spring 38, and a hub 40.

As shown in FIG. 3, the first bracket 30 may include a generally round main body 42 and a pair of mounting lobes 43 that extend outward from the main body 42. The main body 42 may include a central aperture 44 and a tab 45. The mounting lobes 43 may include a plurality of apertures 46 through which fasteners (not shown) may extend to securely attach the first bracket 30 to the seat bottom frame 20 of the seat assembly 12.

As shown in FIG. 3, the second bracket 32 may be generally rectangular and may include a plurality of apertures 48, and a central aperture 49 through which the cross member 28 extends. Fasteners (not shown) may extend through the plurality of apertures 48 to securely attach the second bracket 32 to the seatback frame 18 of the seat assembly 12.

The recliner heart 34 may be mounted to the first and second brackets 30, 32 and may include a guide plate or first plate 50, a ratchet plate or second plate 51, a cam 52, a plurality of pawls 54, a connector disk 56, a plurality of coil springs 58, a control ring 60, and an encapsulation ring 64. The recliner heart 34 may be operable to lock the first recliner mechanism 24, thus preventing relative rotation between the seatback 14 and the seat bottom 16, and to also unlock the first recliner mechanism 24, thus permitting relative rotation between the seatback 14 and the seat bottom 16.

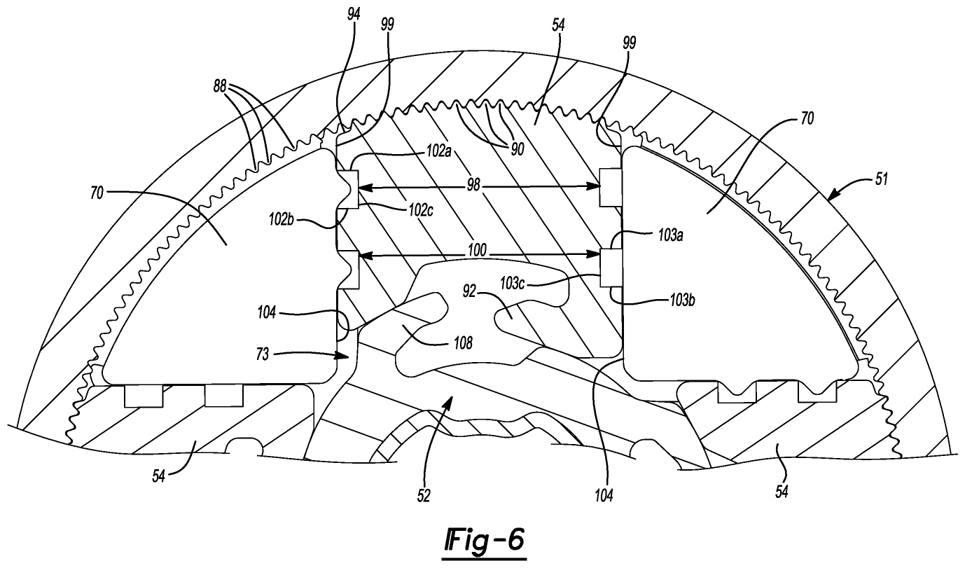

The guide plate 50 may be rotationally fixed relative to the seat bottom 16 and may be attached (e.g., laser welded) to the first bracket 30 and the encapsulation ring 64. The guide plate 50 may be a generally circular shape and may include a plate surface 66 and a rim 68. The plate surface 66 may include an aperture 69 (FIG. 3), a plurality of first protrusions 70 (FIGS. 3-5) and a plurality of second protrusions 72 (FIG. 3). As shown in FIG. 3, the aperture 69 may extend through a center portion of the plate surface 66. The triangular-shape first protrusions 70 may be disposed radially around the aperture 69 and may extend from the plate surface 66, thereby defining first recesses 73 (FIG. 6). Each first recess 73 may be disposed between two of the plurality of first protrusions 70 (FIG. 6). The second protrusions 72 may extend from the plate surface 66 opposite the direction of the first protrusions 70, thereby forming second recesses (not shown). The first recesses 73 and the second recesses (not shown) are adjacent to each other. The rim 68 may extend 360 degrees around a periphery of the plate surface 66 and may be attached (e.g., laser welded) to the first bracket 30 and the encapsulation ring 64.

The ratchet plate 51 may be rotationally fixed to the seatback 14 and may include a plate surface 78 and a rim 80. The plate surface 78 may include an aperture 82 extending through a center portion thereof and a plurality of projections 84 extending from the plate surface 78 opposite the direction of the rim 80. The plurality of projections 84 may be received in corresponding grooves of the second bracket 32 once the recliner heart 34 is mounted to the second bracket 32. The rim 80 may extend 360 degrees around a periphery of the plate surface 78 and may include an inner surface having teeth 88. The teeth 88 may extend 360 degrees around the inner surface of the rim 80.

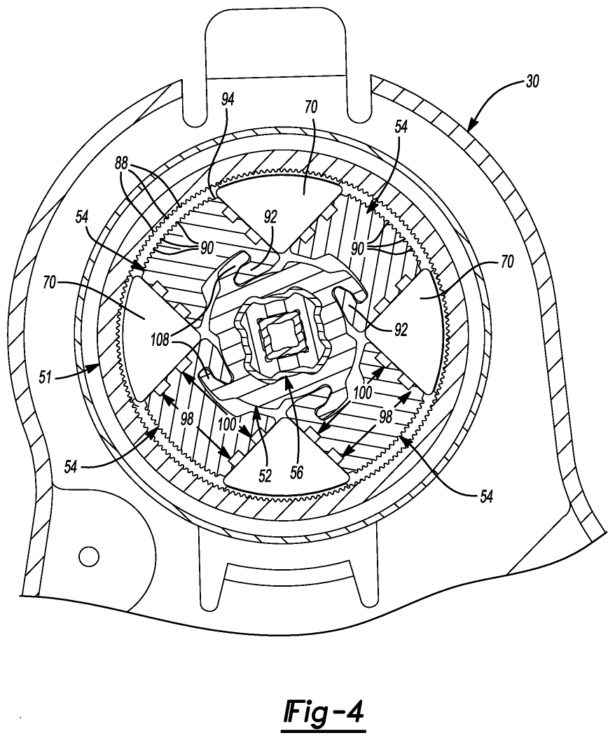

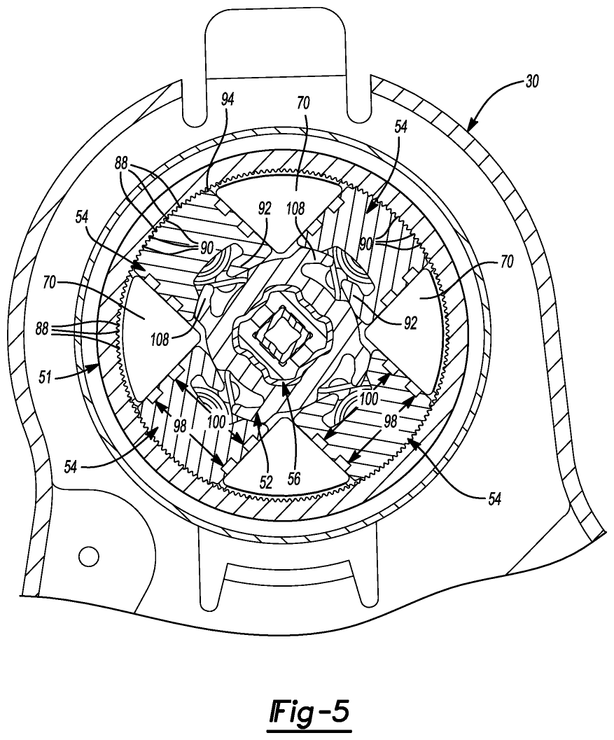

Each pawl 54 may be slidably mounted in a corresponding first recess 73 of the guide plate 50 between a secure position (FIG. 5) in which the pawl 54 is engaged with a portion of the teeth 88 of the ratchet plate 51 and a release position (FIG. 4) in which the pawl 54 is disengaged from the portion of the teeth 88 of the ratchet plate 51. Each pawl 54 may include teeth 90 and a latch 92 at an end opposite the teeth 90. The teeth 90 may be disposed at an edge 94 of the pawl 54 and may be adapted for meshing engagement with a portion of the teeth 88 of the ratchet plate 51 when the pawl 54 is in the secure position. The edge 94 may include a generally arcuate shape to improve engagement between the pawl 54 and the portion of the teeth 88 of the ratchet plate 51.

Each pawl 54 may also include a first pair of rectangular-shaped slots 98 formed in opposing lateral sides 99 thereof and a second pair of rectangular-shaped slots 100 formed in opposing lateral sides 99 thereof. The first pair of slots 98 may be located near the teeth 90 of the pawl 54 and the second pair of slots 100 may be located near the latch 92 of the pawl 54. A plurality of walls 102 (comprising a first wall 102a, a second wall 102b and a third wall 102c) may cooperate to define each slot 98 of the first pair of slots 98 and a plurality of walls 103 (comprising a first wall 103a, a second wall 103b and a third wall 103c) may cooperate to define each slot 100 of the second pair of slots 100. It should be understood that the first and second pair of slots 98, 100 may be of any suitable shape or configuration (e.g., slots having one or more curved walls, straight walls, or a combination of straight and curved walls). It should also be understood that the pawls 54 may have any number of pairs of slots formed in opposing lateral sides 99 thereof (e.g., the pawls 54 may have one or more pairs of slots formed in opposing lateral sides thereof). It should also be understood that the pawls 54 may have one or more slots formed in only one lateral side thereof.

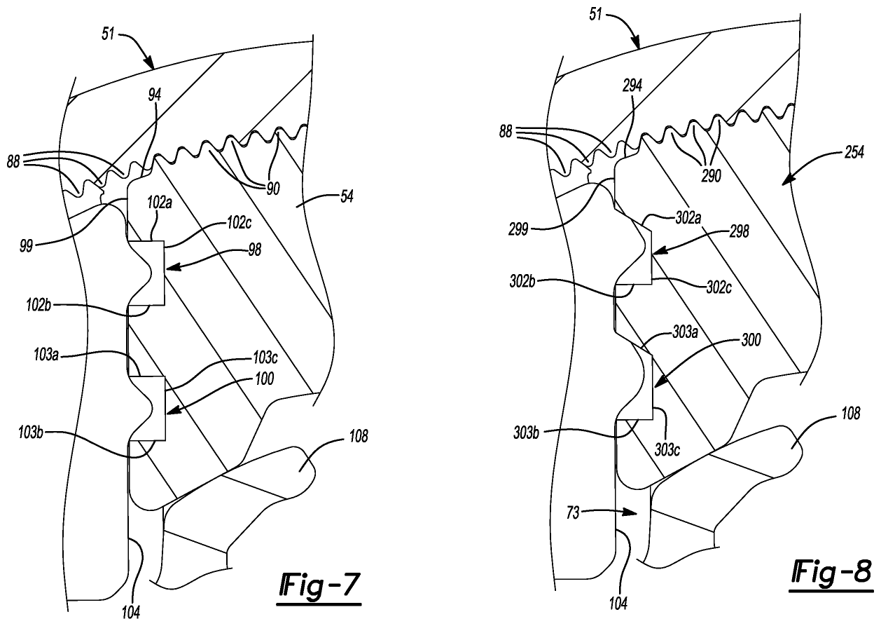

Each lateral side 99 of the pawl 54 faces a lateral side 104 of a respective first protrusion 70 (FIGS. 6 and 7). In this way, material from the first protrusions 70 is allowed to move into at least one slot 98 of the first pair of slots 98 and/or at least one slot 100 of the second pair of slots 100 upon an impact event (e.g., vehicle accident). This, in turn, fixes the pawls 54 in the first recesses 73 and maintain the pawls 54 engagement with the ratchet plate 51 (i.e., the teeth 90 of the pawls 54 maintain engagement with the teeth 88 of the ratchet plate 51) such that the seatback 14 does not move during the impact event.

The cam 52 may be a generally round disk having an aperture 106 and a plurality of radial latch protrusions 108 arranged around the aperture 106. The cam 52 is rotatable relative to the pawls 54 and the ratchet plate 51 such that the latch protrusions 108 can selectively engage the latches 92 of the pawls 54 to move the pawls 54 out of engagement with the teeth 88 of the ratchet plate 51 (i.e., into the release state).

The connector disk 56 is engaged with the cam 52 and the hub 40. The connector disk 56 may include a disk portion 110 and an extrusion 112 extending perpendicularly from the disk portion 110. The disk portion 110 may have a plurality of flanges 114 extending therefrom. Each flange 114 is engaged with a corresponding one of the coil springs 58 disposed in the second recess (not shown). Because each flange 114 is engaged to the corresponding spring 58, the connector disk 56 rotationally biases the cam 52 in a manner that causes the latch protrusions 108 to force the pawls 54 radially outwardly into the secure position, whereby the teeth 90 of the pawls 54 engage the teeth 88 of the ratchet plate 51.

The extrusion 112 of the connector disk 56 is engaged with the hub 40 and the cam 52 such that rotation of the hub 40 (which is caused by rotation of the hand lever 29) causes rotation of the cam 52 to move the pawls 54 radially into and out of engagement with the teeth 88 of the ratchet plate 51.

The outer coil spring 36 may exert a torsional force that biases the first recliner mechanism 24 toward a locked state. The outer coil spring 36 may wrap around the hub 40 and engage the first bracket 30 and the hand lever 29. The inner coil spring 38 may extend around the cross member 28 and may engage the first and second brackets 30, 32 to rotationally bias the seatback 14 toward the upright position relative to the seat bottom 16.

The hub 40 may extend through the length of the recliner heart 34 and may include a first end 116 and a second end 118. The first end 116 may engage the hand lever 29 such that the hub 40 and the hand lever 29 are rotationally fixed to each other. A fastener 120 (e.g., a screw; shown in FIG. 3) may extend through the hand lever 29 and threadably engage the first end 116 of the hub 40. The second end 118 may include an aperture (not shown) that receives an end of the cross member 28 such that the cross member 28 and the hub 40 are rotationally fixed relative to each other. To enable the seatback 14 to pivot relative to the seat bottom 16, a user may pivot the hand lever 29 in a clockwise direction thus rotating the hub 40 (and consequently the cross member 28). Accordingly, clockwise rotation of the cross member 28 causes the cam 52 to similarly rotate in a clockwise direction relative to the plurality of pawls 54, overcoming a counterclockwise rotational bias of the outer coil spring 36.

The structure and function of the second recliner mechanism 26 may be similar or identical to that of the first recliner mechanism 24, and therefore, will not be described again in detail.

The cross member 28 may be a generally rectangular (e.g., square) or generally circular profile and may extend in a cross-vehicle direction. The cross member 28 may connect the first recliner mechanism 24 to the second recliner mechanism 26, and may transmit rotational motion of the first recliner mechanism 24 to the second recliner mechanism 26 to move the second recliner mechanism 26 between the locked and unlocked states simultaneously with motion of the first recliner mechanism 24 between the locked and unlocked states. That is, the cross member 28 transmits torque from the hand lever 29 to the second recliner mechanism 26.

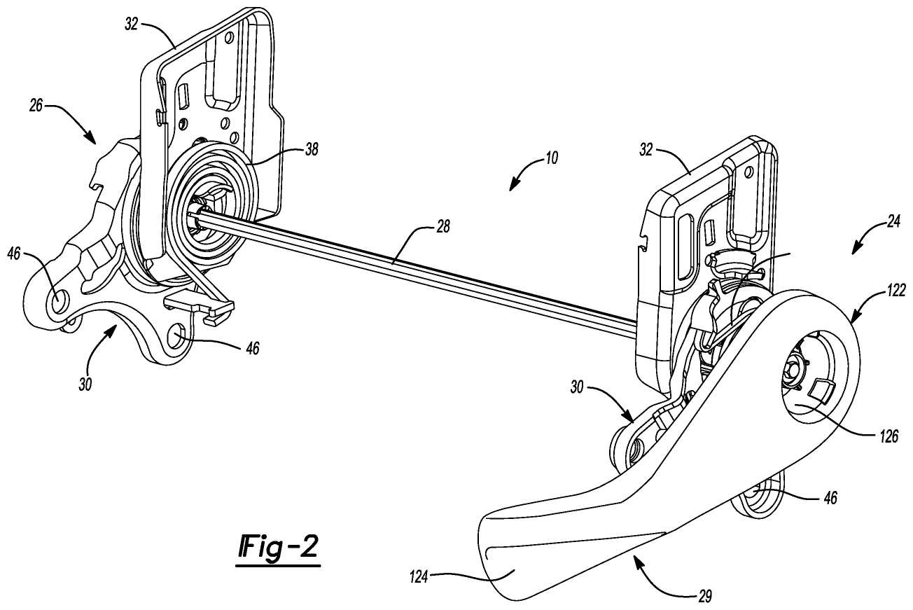

As shown in FIG. 2, the hand lever 29 may include a hub portion 122 and a handle portion 124. The hub portion 122 may include a recess 126. The recess 126 may include an aperture 128 (FIG. 3) through which the fastener 120 extends. The handle portion 124 may extend outward from the hub portion 122 and may be shaped to provide a comfortable gripping surface that a user can grip to actuate the hand lever 29. The hand lever 29 may be securely attached to the first end 116 of the hub 40, so that a rotational movement of the hand lever 29 causes the hub 40 (and consequently the cross member 28) to rotate. This rotational movement may function to lock and unlock the seat recliner mechanisms 24, 26 to selectively prevent and allow rotational motion of the seatback 14 relative to the seat bottom 16.

With continued reference to FIGS. 1-7, operation of the recliner assembly 10 will be described in detail. When a vehicle impact event occurs (e.g., a vehicle accident) that exerts a force to the seatback 14 in a counter-clockwise (or clockwise) direction, the pawls 54 may exert this same force to the lateral sides 104 of the first protrusions 70. This force on the lateral sides 104 of the first protrusions 70 causes deformation of the first protrusions 70. During such deformation, portions of the first protrusions 70 are allowed to move into at least one of the slots 98 and at least one of the slots 100. The material of the first protrusions 70 that are received within the at least one of the slots 98 and the at least one of the slots 100 fixes the pawls 54 in the first recesses 73 and maintain the pawls 54 engagement with the ratchet plate 51 (i.e., the teeth 90 of the pawls 54 maintain engagement with the teeth 88 of the ratchet plate 51) such that the seatback 14 does not move during the impact event.

With reference to FIG. 8, another pawl 254 is provided. A plurality of pawls 254 may be incorporated into the recliner heart 34 described above instead of pawls 54. The structure and function of the pawl 254 may be similar or identical to that of the pawls 54 described above, apart from any exceptions noted below.

The pawl 254 may be slidably mounted in a corresponding first recess 73 of the guide plate 50 between a secure position in which the pawl 254 is engaged with a portion of the teeth 88 of the ratchet plate 51 and a release position in which the pawl 254 is disengaged from the portion of the teeth 88 of the ratchet plate 51. The pawl 254 may include teeth 290 and a latch (not shown; similar or identical to latch 92) at an end opposite the teeth 290. The teeth 290 may be disposed at an edge 294 of the pawl 254 and may be adapted for meshing engagement with a portion of the teeth 88 of the ratchet plate 51 when the pawl 254 is in the secure position. The edge 294 may include a generally arcuate shape to improve engagement between the pawl 254 and the portion of the teeth 88 of the ratchet plate 51.

The pawl 254 may also include a first pair of slots 298 formed in opposing lateral sides 299 thereof (only one slot 298 of the first pair of slots 298 is shown in FIG. 8) and a second pair of slots 300 formed in opposing lateral sides 299 thereof (only one slot 300 of the second pair of slots 300 is shown in FIG. 8). The first pair of slots 298 may be located near the teeth 290 of the pawl 254 and the second pair of slots 300 may be located near the latch (not shown) of the pawl 254. A plurality of walls 302 (comprising a first wall 302a, a second wall 302b and a third wall 302c) may cooperate to define each slot 298 of the first pair of slots 298 and a plurality of walls 303 (comprising a first wall 303a, a second wall 303b and a third wall 303c) may cooperate to define each slot 300 of the second pair of slots 300. The first wall 302a of the walls 302 and the first wall 303a of walls 303 may be angled (i.e. non-perpendicular angle) relative to the lateral sides 104 of the first protrusions 70.

Each lateral side 299 of the pawl 254 faces a lateral side 104 of a respective first protrusion 70. In this way, when a vehicle impact event occurs (e.g., a vehicle accident) that exerts a force to the seatback 14 in a counter-clockwise (or clockwise) direction, the pawl 254 may exert this same force to the lateral sides 104 of the first protrusions. This force on the lateral sides 104 of the first protrusions 70 causes the deformation of the first protrusions 70. During search deformation, portions of the first protrusions 70 are allowed to move into at least one of the slots 298 and at least one of the slots 300. The material of the first protrusions 70 that are received within the at least one of the slots 298 and the at least one of the slots 300 fixes the pawl 254 in the first recess 73 and maintains the pawl 254 engagement with the ratchet plate 51 (i.e., the teeth 290 of the pawl 254 maintains engagement with the teeth 88 of the ratchet plate 51) such that the seatback 14 does not move during the impact event. The material from the first protrusions 70 may contact the angled first walls 302a, 303a such that the pawl 254 is forced radially outwardly into further engagement with the teeth 88 of the ratchet plate 51.

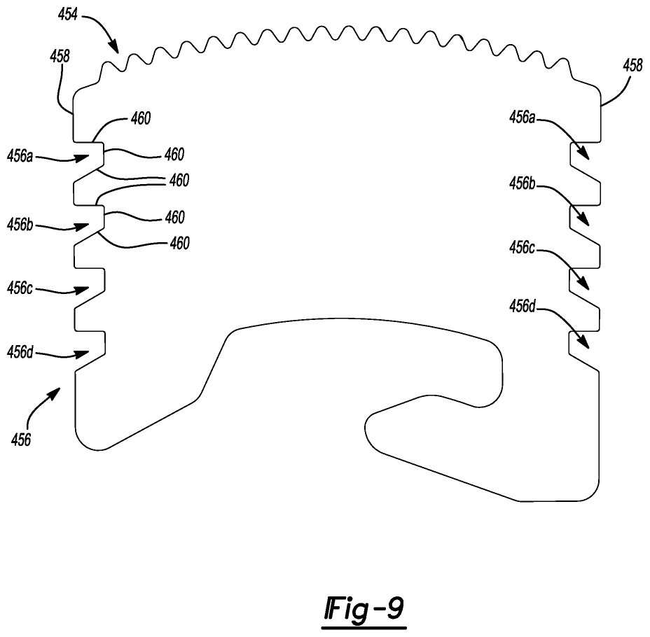

With reference to FIG. 9, another pawl 454 is provided. A plurality of pawls 454 may be incorporated into the recliner heart 34 described above instead of pawls 54, 254. The structure and function of the pawl 454 may be similar or identical to that of the pawls 54, 254 described above, apart from any exceptions noted below. The pawl 454 may include a plurality of pairs of slots 456 (comprising the pairs of slots 456a, 456b, 456c, 456d) formed in opposing lateral sides 458 thereof. Each slot 456 of the plurality of pairs of slots 456 may include a plurality of walls 460. One or more of the walls 460 may be angled (i.e. non-perpendicular angle) relative to the lateral side 458 of the pawl 454.

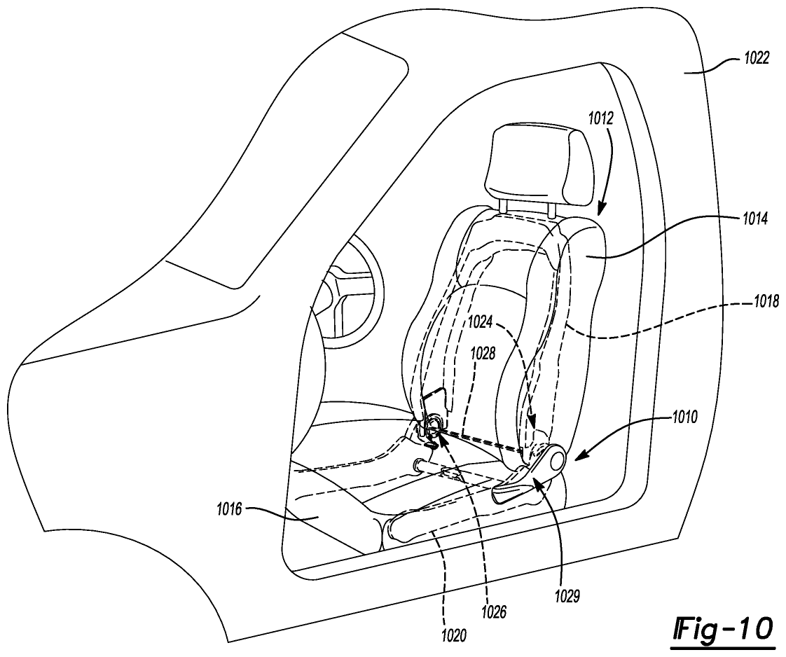

With reference to FIGS. 10-12, another recliner assembly 1010 is provided that may be incorporated into a vehicle seat assembly 1012 having a seatback 1014 and a seat bottom 1016. The seatback 1014 and seat bottom 1016 may include a seatback frame 1018 and a seat bottom frame 1020 respectively. The seat assembly 1012 may be positioned in a vehicle 1022, as shown in FIG. 10. The recliner assembly 1010 may include a first recliner mechanism 1024, a second recliner mechanism 1026, a cross member 1028, and a hand lever or release lever 1029.

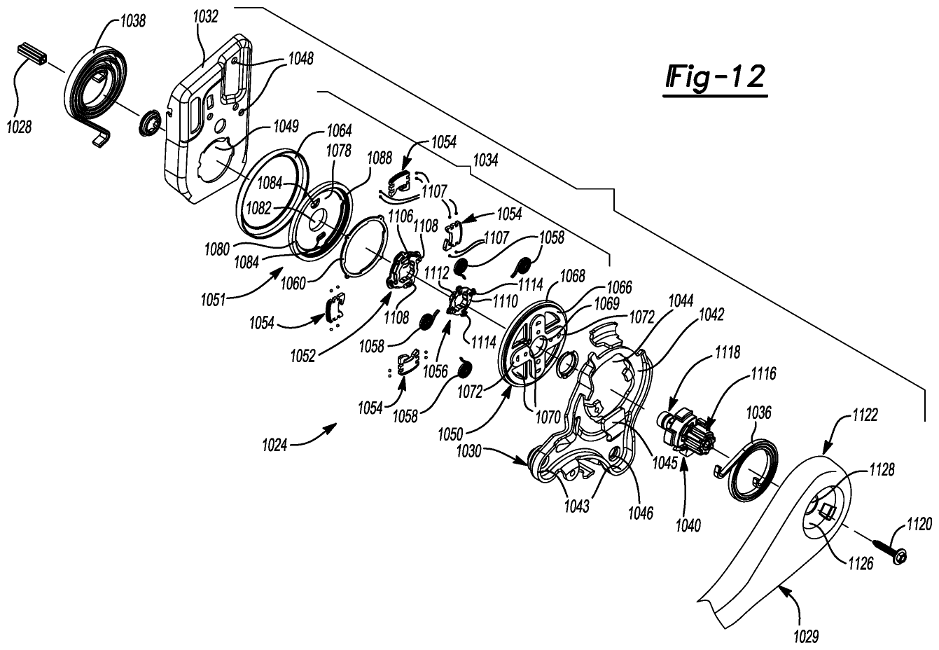

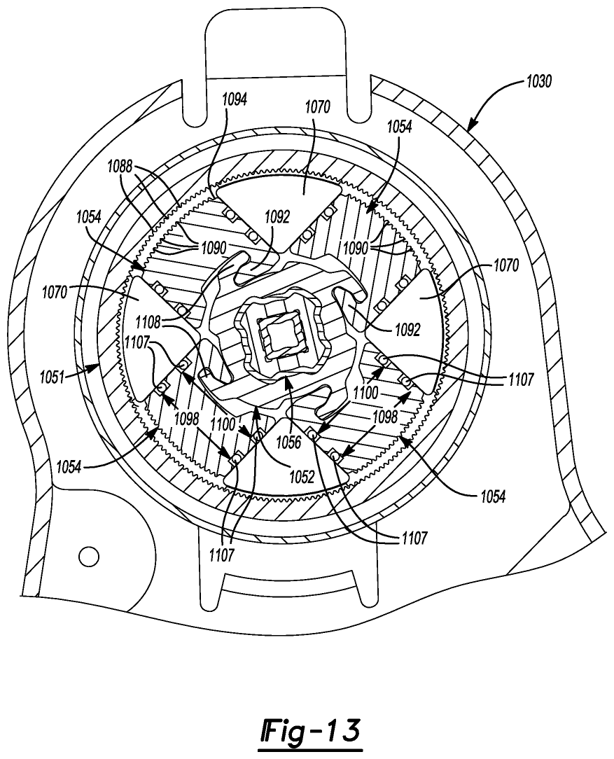

The first and second recliner mechanisms 1024, 1026 may be operable in a locked state preventing relative rotation between the seatback 1014 and the seat bottom 1016 and an unlocked state permitting relative rotation between the seatback 1014 and the seat bottom 1016 among an upright position (FIG. 10), a rearward reclined position (not shown) and a forward dump position (not shown). As shown in FIG. 12, the first recliner mechanism 1024 may include a first bracket 1030, a second bracket 1032, a recliner heart (or locking mechanism) 1034, an outer coil spring 1036, an inner coil spring 1038, and a hub 1040.

As shown in FIG. 12, the first bracket 1030 may include a generally round main body 1042 and a pair of mounting lobes 1043 that extend outward from the main body 1042. The main body 1042 may include a central aperture 1044 and a tab 1045. The mounting lobes 1043 may include a plurality of apertures 1046 through which fasteners (not shown) may extend to securely attach the first bracket 1030 to the seat bottom frame 1020 of the seat assembly 1012.

As shown in FIG. 12, the second bracket 1032 may be generally rectangular and may include a plurality of apertures 1048, and a central aperture 1049 through which the cross member 1028 extends. Fasteners (not shown) may extend through the plurality of apertures 1048 to securely attach the second bracket 1032 to the seatback frame 1018 of the seat assembly 1012.

The recliner heart 1034 may be mounted to the first and second brackets 1030, 1032 and may include a guide plate or first plate 1050, a ratchet plate or second plate 1051, a cam 1052, a plurality of pawls 1054, a connector disk 1056, a plurality of coil springs 1058, a control ring 1060, and an encapsulation ring 1064. The recliner heart 1034 may be operable to lock the first recliner mechanism 1024, thus preventing relative rotation between the seatback 1014 and the seat bottom 1016, and to also unlock the first recliner mechanism 1024, thus permitting relative rotation between the seatback 1014 and the seat bottom 1016.

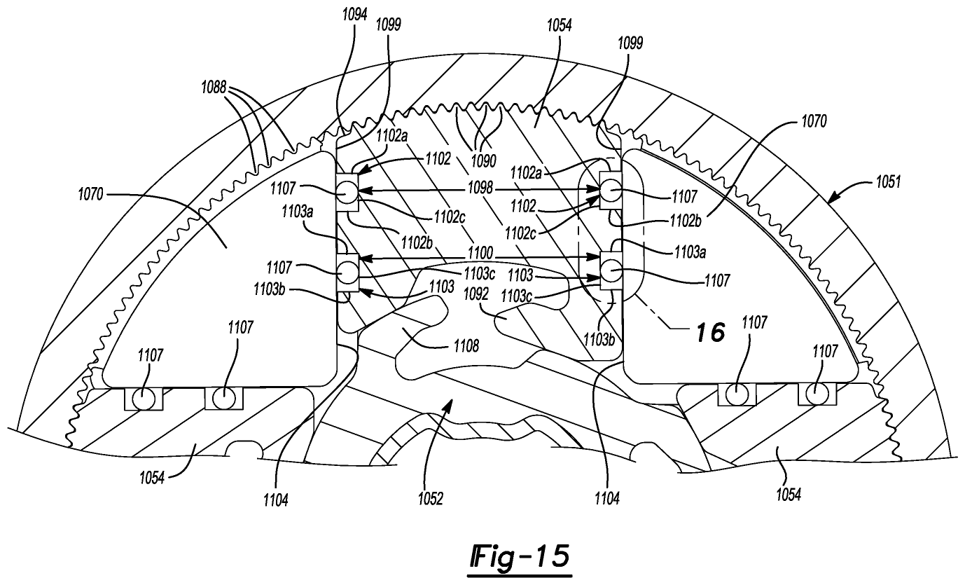

The guide plate 1050 may be rotationally fixed relative to the seat bottom 1016 and may be attached (e.g., laser welded) to the first bracket 1030 and the encapsulation ring 1064. The guide plate 1050 may be a generally circular shape and may include a plate surface 1066 and a rim 1068. The plate surface 1066 may include an aperture 1069 (FIG. 12), a plurality of first protrusions 1070 (FIGS. 12-14) and a plurality of second protrusions 1072 (FIG. 12). As shown in FIG. 12, the aperture 1069 may extend through a center portion of the plate surface 1066. The triangular-shape first protrusions 1070 may be disposed radially around the aperture 1069 and may extend from the plate surface 1066, thereby defining first recesses 1073 (FIG. 15). Each first recess 1073 may be disposed between two of the plurality of first protrusions 1070 (FIG. 15). The second protrusions 1072 may extend from the plate surface 1066 opposite the direction of the first protrusions 1070, thereby forming second recesses (not shown). The first recesses 1073 and the second recesses (not shown) are adjacent to each other. The rim 1068 may extend 360 degrees around a periphery of the plate surface 1066 and may be attached (e.g., laser welded) to the first bracket 1030 and the encapsulation ring 1064.

The ratchet plate 1051 may be rotationally fixed to the seatback 1014 and may include a plate surface 1078 and a rim 1080. The plate surface 1078 may include an aperture 1082 extending through a center portion thereof and a plurality of projections 1084 extending from the plate surface 1078 opposite the direction of the rim 1080. The plurality of projections 1084 may be received in corresponding grooves of the second bracket 1032 once the recliner heart 1034 is mounted to the second bracket 1032. The rim 1080 may extend 360 degrees around a periphery of the plate surface 1078 and may include an inner surface having teeth 1088. The teeth 1088 may extend 360 degrees around the inner surface of the rim 1080.

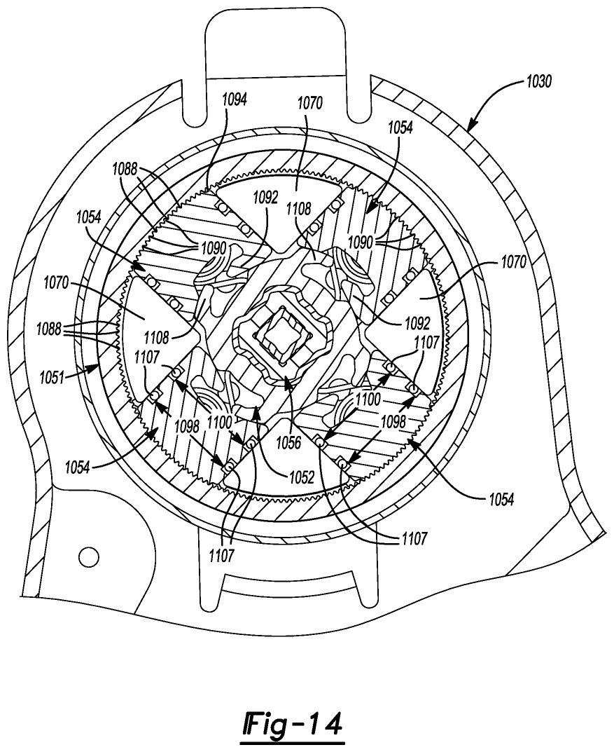

Each pawl 1054 may be slidably mounted in a corresponding first recess 1073 of the guide plate 1050 between a secure position (FIG. 14) in which the pawl 1054 is engaged with a portion of the teeth 1088 of the ratchet plate 1051 and a release position (FIG. 13) in which the pawl 1054 is disengaged from the portion of the teeth 1088 of the ratchet plate 1051. Each pawl 1054 may include teeth 1090 and a latch 1092 at an end opposite the teeth 1090. The teeth 1090 may be disposed at an edge 1094 of the pawl 1054 and may be adapted for meshing engagement with a portion of the teeth 1088 of the ratchet plate 1051 when the pawl 1054 is in the secure position. The edge 1094 may include a generally arcuate shape to improve engagement between the pawl 1054 and the portion of the teeth 1088 of the ratchet plate 1051.

Each pawl 1054 may also include first rectangular-shaped slots 1098 formed in opposing lateral sides 1099 thereof and second rectangular-shaped slots 1100 formed in opposing lateral sides 1099 thereof. The first slots 1098 may be located near the teeth 1090 of the pawl 1054 and the second slots 1100 may be located near the latch 1092 of the pawl 1054. Each of the first slots 1098 may be defined by a plurality of walls 1102 (comprising a first wall 1102a, a second wall 1102b and a third wall 1102c). Each of the second slots 1100 may be defined by a plurality of walls 1103 (comprising a first wall 1103a, a second wall 1103b and a third wall 1103c). It should be understood that the first and second slots 1098, 1100 may be of any suitable shape or configuration (e.g., slots having one or more curved walls, straight walls, or a combination of straight and curved walls). It should also be understood that the pawls 1054 may have any number of slots formed in opposing lateral sides 1099 thereof (e.g., the pawls 1054 may have one or more slots formed in opposing lateral sides thereof). It should also be understood that the pawls 1054 may have one or more slots formed in only one lateral side thereof.

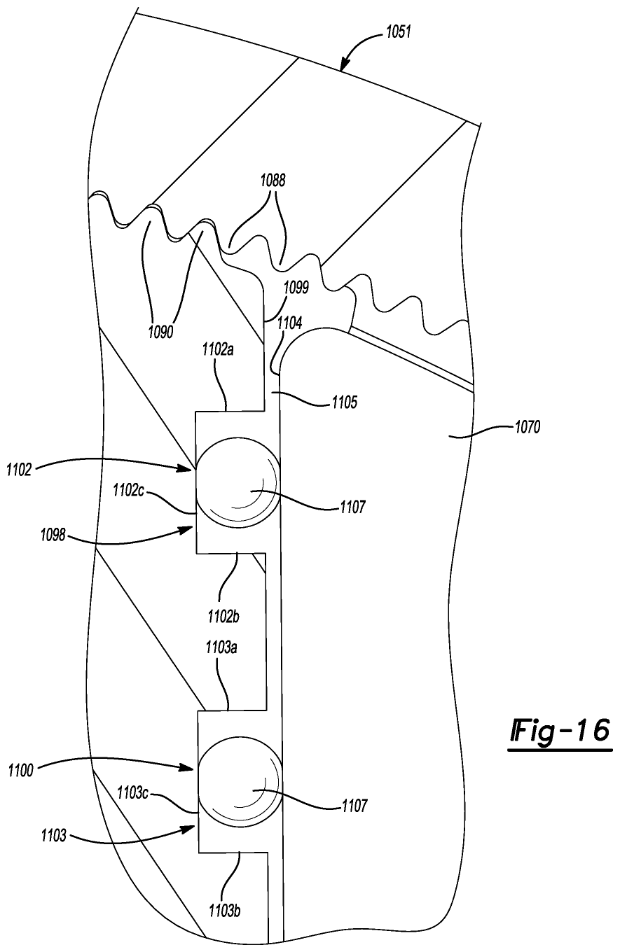

Each lateral side 1099 of the pawl 1054 faces a lateral side 1104 of a respective first protrusion 1070 (FIGS. 15 and 16). As shown in FIG. 16, a clearance gap 1105 may exist between each lateral side 1099 of the pawl 1054 and the lateral side 1104 of the respective first protrusion 1070 that the lateral side 1099 is facing. In this way, each pawl 1054 may be easily movable between the secure position and the release position.

As shown in FIGS. 13-16, a compression member 1107 (e.g., the compression member 1107 may be a ball or sphere, cylinder, spheroid, rectangular prism, or any other shape) may be force-fitted into each of the first and second slots 1098, 1100 so that the compression members 1107 are under compression within each of the slots 1098, 1100. Each compression member 1107 may be made of a polymeric or rubber material, for example. The compression member 1107 in each of the slots 1098 may be in contact with the lateral side 1104 of a respective first protrusion 1070 and with the third wall 1102c of the slot 1098. Similarly, the compression member 1107 in each of the slots 1100 may also be in contact with the lateral side 1104 of a respective first protrusion 1070 and with the third wall 1103c of the slot 1100. In some configurations, a plurality of the compression members 1107 may be force-fitted into each slot 1098, 1100.

The cam 1052 may be a generally round disk having an aperture 1106 and a plurality of radial latch protrusions 1108 arranged around the aperture 1106. The cam 1052 is rotatable relative to the pawls 1054 and the ratchet plate 1051 such that the latch protrusions 1108 can selectively engage the latches 1092 of the pawls 1054 to move the pawls 1054 out of engagement with the teeth 1088 of the ratchet plate 1051 (i.e., into the release state).

The connector disk 1056 is engaged with the cam 1052 and the hub 1040. The connector disk 1056 may include a disk portion 1110 and an extrusion 1112 extending perpendicularly from the disk portion 1110. The disk portion 1110 may have a plurality of flanges 1114 extending therefrom. Each flange 1114 is engaged with a corresponding one of the coil springs 1058 disposed in the second recess (not shown). Because each flange 1114 is engaged to the corresponding spring 1058, the connector disk 1056 rotationally biases the cam 1052 in a manner that causes the latch protrusions 1108 to force the pawls 1054 radially outwardly into the secure position, whereby the teeth 1090 of the pawls 1054 engage the teeth 1088 of the ratchet plate 1051.

The extrusion 1112 of the connector disk 1056 is engaged with the hub 1040 and the cam 1052 such that rotation of the hub 1040 (which is caused by rotation of the hand lever 1029) causes rotation of the cam 1052 to move the pawls 1054 radially into and out of engagement with the teeth 1088 of the ratchet plate 1051.

The outer coil spring 1036 may exert a torsional force that biases the first recliner mechanism 1024 toward a locked state. The outer coil spring 1036 may wrap around the hub 1040 and engage the first bracket 1030 and the hand lever 1029. The inner coil spring 1038 may extend around the cross member 1028 and may engage the first and second brackets 1030, 1032 to rotationally bias the seatback 1014 toward the upright position relative to the seat bottom 1016.

The hub 1040 may extend through the length of the recliner heart 1034 and may include a first end 1116 and a second end 1118. The first end 1116 may engage the hand lever 1029 such that the hub 1040 and the hand lever 1029 are rotationally fixed to each other. A fastener 1120 (e.g., a screw; shown in FIG. 12) may extend through the hand lever 1029 and threadably engage the first end 1116 of the hub 1040. The second end 1118 may include an aperture (not shown) that receives an end of the cross member 1028 such that the cross member 1028 and the hub 1040 are rotationally fixed relative to each other. To enable the seatback 1014 to pivot relative to the seat bottom 1016, a user may pivot the hand lever 1029 in a clockwise direction thus rotating the hub 1040 (and consequently the cross member 1028). Accordingly, clockwise rotation of the cross member 1028 causes the cam 1052 to similarly rotate in a clockwise direction relative to the plurality of pawls 1054, overcoming a counterclockwise rotational bias of the outer coil spring 1036.

The structure and function of the second recliner mechanism 1026 may be similar or identical to that of the first recliner mechanism 1024, and therefore, will not be described again in detail.

The cross member 1028 may be a generally rectangular (e.g., square) or generally circular profile and may extend in a cross-vehicle direction. The cross member 1028 may connect the first recliner mechanism 1024 to the second recliner mechanism 1026, and may transmit rotational motion of the first recliner mechanism 1024 to the second recliner mechanism 1026 to move the second recliner mechanism 1026 between the locked and unlocked states simultaneously with motion of the first recliner mechanism 1024 between the locked and unlocked states. That is, the cross member 1028 transmits torque from the hand lever 1029 to the second recliner mechanism 1026.

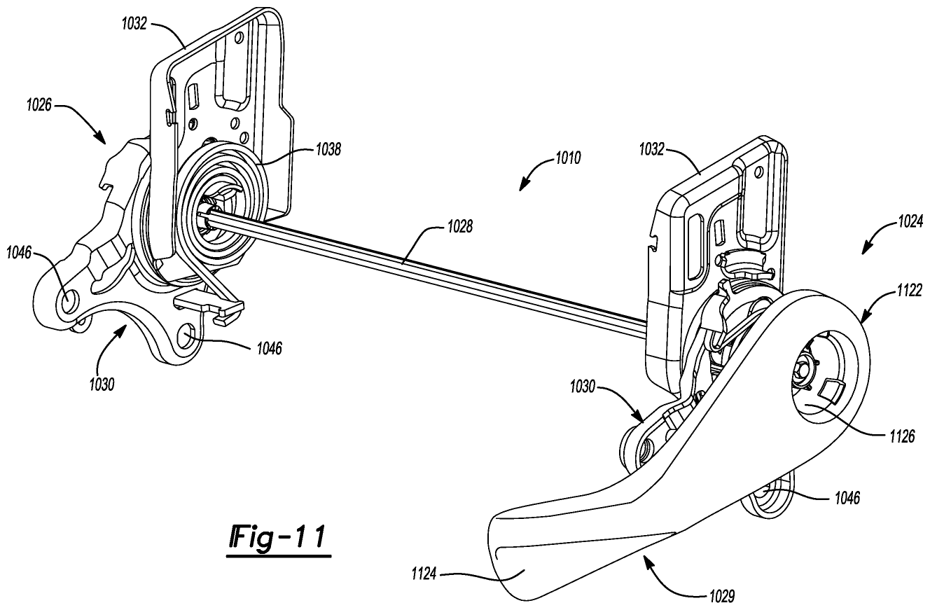

As shown in FIG. 11, the hand lever 1029 may include a hub portion 1122 and a handle portion 1124. The hub portion 1122 may include a recess 1126. The recess 1126 may include an aperture 1128 (FIG. 12) through which the fastener 1120 extends. The handle portion 1124 may extend outward from the hub portion 1122 and may be shaped to provide a comfortable gripping surface that a user can grip to actuate the hand lever 1029. The hand lever 1029 may be securely attached to the first end 1116 of the hub 1040, so that a rotational movement of the hand lever 1029 causes the hub 1040 (and consequently the cross member 1028) to rotate. This rotational movement may function to lock and unlock the seat recliner mechanisms 1024, 1026 to selectively prevent and allow rotational motion of the seatback 1014 relative to the seat bottom 1016.

With continued reference to FIGS. 10-16, operation of the recliner assembly 1010 will be described in detail. When a vehicle is traveling along a rough terrain, for example, the seat assembly 1012 may experience vibration, which, in turn, may cause the ratchet plate 1051 and the pawls 1054 to vibrate. The compression members 1107 force-fitted in the slots 1098, 1100 may dampen vibration of the ratchet plate 1051 and the pawls 1054, which reduces noise (e.g., buzz-squeak-rattle (BSR)) of the recliner assembly 1010.

The compression member 1107 under compression in each of the slots 1098 may be in contact with the lateral side 1104 of a respective first protrusion 1070 and with the third wall 1102c of the slot 1098. The compression member 1107 under compression in each of the slots 1100 may be in contact with the lateral side 1104 of a respective first protrusion 1070 and with the third wall 1103c of the slot 1100. In this way, the compression member 1107 in each of the slots 1098, 1100 takes up clearance between the pawls 1054 and respective first protrusions 1070, which reduces chucking (i.e., movement or free play between the pawls 1054 and the ratchet plate 1051 when the pawls 1054 are in the secure position). Reducing chucking between the pawls 1054 and the ratchet plate 1051 restricts movement of the seatback 1014 relative to the seat bottom 1016 when the recliner heart 1034 is in the locked position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A recliner heart comprising:
a first plate defining a recess;
a second plate including a first inner diametrical surface having teeth formed thereon; and
a pawl slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates,
wherein a lateral side of the pawl includes a first slot.

2. The recliner heart of claim 1, wherein material from the first plate is allowed to deform into the first slot upon an impact event.

3. The recliner heart of claim 1, wherein the first plate includes a plurality of protrusions, and wherein the pawl is disposed in the recess defined between adjacent protrusions.

4. The recliner heart of claim 3, wherein the lateral side of the pawl faces a lateral side of a respective protrusion of the plurality of protrusions.

5. The recliner heart of claim 4, wherein material from the respective protrusion is allowed to deform into the first slot upon an impact event.

6. The recliner heart of claim 5, wherein the pawl is fixed in the recess when the pawl is in the secure position and material from the respective protrusion moves into the first slot.

7. The recliner heart of claim 5, wherein a second slot is formed in the lateral side of the pawl, and wherein material from the respective protrusion is allowed to move into the second slot upon the impact event.

8. The recliner heart of claim 7, wherein a plurality of second walls cooperate to define the second slot.

9. The recliner heart of claim 1, wherein a plurality of first walls cooperate to define the first slot.

10. The recliner heart of claim 9, wherein at least one of the plurality of first walls is angled.

11. The recliner heart of claim 1, wherein a second slot is formed in an opposing lateral side of the pawl.

12. A recliner heart comprising:
a first plate including a plate surface having a plurality of protrusions extending therefrom, the plurality of protrusions defining a recess therebetween;
a second plate including a first inner diametrical surface having teeth formed thereon; and
a pawl slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates,
wherein opposing lateral sides of the pawl include a first pair of slots.

13. The recliner heart of claim 12, wherein each lateral side of the pawl faces a lateral side of a respective protrusion of the plurality of protrusions.

14. The recliner heart of claim 13, wherein material from one of the plurality of protrusions is allowed to deform into one slot of the first pair of slots upon an impact event.

15. The recliner heart of claim 14, wherein the pawl is fixed in the recess when the pawl is in the secure position and material from the one of the plurality of protrusions deforms into the one slot of the first pair of slots.

16. The recliner heart of claim 15, wherein a plurality of first walls cooperate to define each slot of the first pair of slots, and wherein at least one of the plurality of first walls is angled relative to the opposing lateral sides of the pawl.

17. The recliner heart of claim 16, wherein the pawl includes a second pair of slots formed in the opposing lateral sides, and wherein material from the one of the two of the plurality of protrusions is allowed to deform into one slot of the second pair of slots upon the impact event.

18. The recliner heart of claim 17, wherein a plurality of second walls cooperate to define each slot of the second pair of slots, and wherein at least one of the plurality of second walls is angled relative to the opposing lateral sides of the pawl.

19. The recliner heart of claim 12, wherein the pawl includes a second pair of slots formed in the opposing lateral sides, and wherein material from the first plate is allowed to deform into one slot of the first pair of slots and one slot of the second pair of slots upon an impact event.

20. A vehicle seat assembly comprising:
a seat bottom;
a seatback that is movable relative to the seat bottom; and
a recliner mechanism connected to the seat bottom and the seatback and operable to selectively allow and restrict movement of the seatback relative to the seat bottom, wherein the recliner mechanism includes a recliner heat, wherein the recliner heart includes:
a first plate defining a recess;
a second plate including a first inner diametrical surface having teeth formed thereon; and
a pawl slidably disposed in the recess between a secure position in which the pawl is engaged with a portion of the teeth of the second plate to restrict relative rotation between the first and second plates and a release position in which the pawl is disengaged from the portion of the teeth of the second plate to allow relative rotation between the first and second plates,
wherein at least one lateral side of the pawl includes at least one slot.
